(19) United States
(12) Patent Application Publication
(10) Pub. No.: US 2024/0331558 A1
(43) Pub. Date: Oct. 3, 2024

(54) System and Method for Measuring and Improving Literacy by Deep Learning and Large Language Model Assisted Reading

(71) Applicant: Ruhul Quddus, West Windsor, NJ (US)

(72) Inventor: Ruhul Quddus, West Windsor, NJ (US)

(73) Assignee: Ruhul Quddus, West Windsor, NJ (US)

(21) Appl. No.: 18/611,932

(22) Filed: Mar. 21, 2024

Related U.S. Application Data
(60) Provisional application No. 63/456,076, filed on Mar. 31, 2023.

(51) Int. Cl. G09B 5/06; G06F 16/955; G06F 40/134; H04L 51/02

(52) U.S. Cl. CPC G09B 5/06; G06F 16/9558; G06F 40/134; H04L 51/02

(57) ABSTRACT

The method and system described herein provide a novel safe approach to enhancing and measuring the understanding of technical, science or other documents. By identifying difficult concepts and providing additional safety verified resources to aid comprehension, the system enables readers to better understand complex technical documents. The system may be implemented as a web-based application or as a plug-in for existing reading applications and may be customized for specific domains. The system works on existing documents. Content owners do not have to recreate content to fit a new format. The system and method have broad applicability beyond making it easier for students to understand articles. The system may provide feedback to content authors, enable teachers to identify students' effort in reading a document. It can enable businesses to better engage with their customers while reading their existing marketing and technical contents online.

### PRIORITY CLAIM

This patent application claims priority to the U.S. provisional patent application No. 63/456,076 having the filing date of Mar. 31, 2023, and entitled “System and Method for Measuring and Improving Literacy by Deep Learning and Large Language Model Assisted Reading.”

### FIELD OF THE INVENTION

The present invention relates to computer systems and methods for enhancing and measuring comprehension of documents, and more particularly, to a system and method that identifies difficult terms, facts and concepts and dynamically provides supplementary information to the reader, tailored to the reader's level of understanding, using a large language model and user behavior analysis.

The system and method may also provide feedback to document authors, helping to improve the clarity and comprehensibility of their documents.

The system and method can also be used for tracking how much effort a student spent on reading an assigned document.

The system and method can be used by companies to help potential customers understand marketing documents and technical papers and initiate online live engagement with the readers.

The system and method can be used to get a summary of small and large documents (for example, larger than 100 pages) and answer questions in the context of the document.

The system and method are designed to work on existing content, without the need to create new content to fit a new format.

### BACKGROUND

Over 54% of adults in the U.S. have a literacy level below 54%. Just in the Trenton NJ area, nearly 5000 jobs are unfilled because employers cannot find qualified applicants. Many are unfilled because the minimum requirement for the position is to have a GED or High School diploma. Low literacy is a persistent cause of poverty in the U.S. In Trenton Public High School, nearly 7 out of 10 students read below grade level.

Increasing the number of college graduates in STEM is a national priority. Numerous costly programs are in place to support STEM education. Yet, we are still behind in the percentage of undergraduate degrees earned in STEM, worldwide: the U.S. holds 9.5%, whereas China holds 26% and India 29.2%. The gap is only increasing every year. In addition, there is a dramatic lack of diversity in STEM graduates. Underrepresented minorities represent 25.9% of students who graduate with a STEM degree, yet they are 35.9% of the population. Women STEM graduates represent 32.4% of students who graduate with a STEM degree, yet they are 50.8% of the population. See Rawlings JS. Primary literature in the undergraduate immunology curriculum: strategies, challenges, and opportunities. Front Immunol. 2019; 1857; 10 doi: 10.3389/fimmu.2019.01857.

There are many persistent causes for poverty as well as the low rate of STEM graduates. However, one consistent cause is low literacy rates. There are many root causes for low literacy rates as well, but once a student falls behind, the depressing momentum continues to push them down the hill. Readers are frustrated by words they do not understand. It becomes easy to lose attention when reading is happening without comprehension. The stigma of low literacy prevents readers from asking for help. Students, especially in underserved communities, lack tutors or teachers to ask questions when needed.

One of the most cost-effective ways to address the above disparities is to enable our students to help themselves as they are reading in any setting. Self-motivated learners are some of the best learners.

In the field of education and self-learning, there is a need for effective methods to assist users in comprehending complex documents. Technical, scientific, or any informative documents often include concepts that may be difficult for some readers to understand. This can lead to frustration, disinterest, and ultimately, poor learning outcomes. Traditional methods of aiding understanding, such as providing selective definitions or illustrations, may not be sufficient for all readers or may be too generic to address individual needs or could be too distracting if the user has to go to another page to get the definition.

Embodiments of the present invention utilize deep learning, large language models, and reinforcement learning to provide assistance when the reader requires help in understanding a difficult term or concept, and to identify how well a reader is understanding an article. We are proposing an innovative version of AI (artificial intelligence) as a personal tutor to help someone read better. The invention highlights key terms, topics, and facts from the context of the reader's background. If the readers have difficulty understanding a term, they can click on a highlight to see a quick definition, illustration, video. The reader can also engage with an AI tool to ask questions in the context of the article and topic of interest. Based on the reader's behavior in clicking on highlighted items, scroll speed, duration read, and other characteristics of the reader, our inventions identify the level of the reader's understanding. By gaining insight into the reader's level of comprehension of any reading material, further actions can be taken to improve their understanding. For example, the invention can provide definitions of challenging industry-specific concepts from the context of the reader's understanding, a chat mechanism to engage an AI or an expert to learn more or ask clarifying questions or provide a link to content that can help the reader understand a concept more in depth.

The invention provides a mechanism to use multiple models to verify the definitions or answers given and its safety with the context of the reader. It ensures that the content being presented to the reader is safe and accurate. The owner/teacher/publisher can manually edit the content of the pop-up box, or request that AI create different content. This is to reject any inappropriate content. This process can have automatic guardrails that check content before it is shown in a pop-up box and prevent inappropriate content from showing. The system can then generate new content to show in the pop-box.

To the content owner/teacher/publisher, we can provide actionable insights to understand the types of readers engaging with their content, how well are the readers understanding the concepts, and engage with those users who require valuable help.

### SUMMARY OF THE INVENTION

The present invention provides a system and method for enhancing the understanding of documents and measuring the understanding of the reader in empirical terms. The system and method identify concepts (difficult terms, facts, key concepts, and summary), highlighting them within the text, and providing definitions, illustrations, videos, and other supplementary information tailored to the reader's level of understanding.

Accordingly, in one aspect, the present invention provides a system for enhancing understanding of documents, comprising: a) a plurality of user devices configured to capture user behavior data; b) a cluster of computing devices, having memory and location architecture, configured to store and process data and artificial intelligence models; and c) a set of servers configured to receive, process, and deliver enhanced documents to the user devices.

In another aspect, the present invention provides a method for enhancing understanding of technical, scientific or any documents, comprising one, some or all of the below techniques.
1. Creating a dictionary of difficult terms, facts, and concepts from a given document using generative AI.
2. Automatically providing definitions for each term, fact or concept, tailored to different levels of understanding using generative AI.
3. Providing a method to ensure the accuracy and safety of the AI definition of concepts.
4. Processing a document to identify and highlight difficult terms, facts, or concepts based on the dictionary; Tags (i.e. html tags) are embedded into the original format of the document to highlight key concepts and insert definitions. This preserves the format of the original document. A new document with the newly embedded tags with generative AI information is published.
5. Allowing users to access supplementary information related to the highlighted concepts. These could include contextual definition, illustration, videos, audios based on the reader's characteristics using click, tap, touch, or other means of selection such as staring at a word or phrase or saying the word or phrase vocally.
6. Allowing the reader to engage with an AI chatbot for further inquiry in the context of the document and highlighted item. For example, allowing for a summary or key points of the document or section of the document. The document can consist of tens to hundreds to thousands of pages.
7. Tracking user behavior data to assess the reader's level of understanding, interest, and satisfaction.
8. Utilizing machine learning, deep learning, transformers, reinforcement learning, and other generative AI algorithms to model and predict the reader's level of understanding, interest, and satisfaction based on the collected data.
9. Providing dynamic feedback in real time (different definition, or additional insight, new illustration, etc.) to the reader based on trained AI model to optimize understanding and the reader's interactions with the supplementary information.
10. Facilitating conversations with an automated system or human to further discuss the difficult concepts.

These and other features, aspects, and advantages of the present invention will become better understood with reference to the following description and appended claims.

### BRIEF DESCRIPTION OF THE FIGURES

FIG. 1 illustrates an exemplary process flow diagram of the methodology of the present invention;

FIG. 2 illustrates an exemplary flow diagram of the methodology for creating a dictionary;

FIG. 3 illustrates an exemplary flow diagram of the methodology for highlighting content;

FIG. 4 illustrates an exemplary flow diagram of the methodology for tracking the reading;

FIG. 5 illustrates an exemplary flow diagram of the methodology for modeling a user's behavior;

FIG. 6 illustrates an exemplary flow diagram of the methodology for providing feedback;

FIG. 7 illustrates an exemplary flow diagram of the methodology for starting a chat;

FIG. 8 illustrates an exemplary architecture diagram in which embodiments of the present invention can be implemented;

FIG. 9A illustrates an exemplary document according to an embodiment of the present invention;

FIG. 9B illustrates another exemplary document according to an embodiment of the present invention;

FIG. 9C illustrates an exemplary document, a pop-up, and a chat box according to an embodiment of the present invention;

FIG. 10 illustrates an exemplary flow diagram of the methodology for highlighting a document by using feedback;

FIG. 11 illustrates examples of scroll behavior; and

FIG. 12 illustrates an exemplary architecture diagram in which embodiments of the present invention can be implemented.

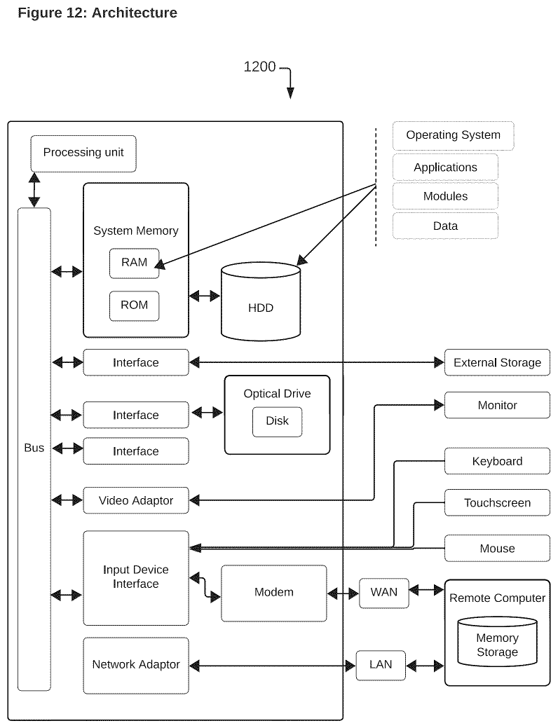

### DESCRIPTION OF THE PREFERRED EMBODIMENTS

The preferred embodiments of the present invention will now be described with reference to the accompanying figures. In the figures, like reference numerals designate corresponding parts throughout the different views.

Referring now to the figures, the systems and methods of the present invention are illustrated, in which different terms, facts, concepts in documents are identified, highlighted, and supplemented with definitions, illustrations, videos, and other information tailored to the reader's level of understanding.

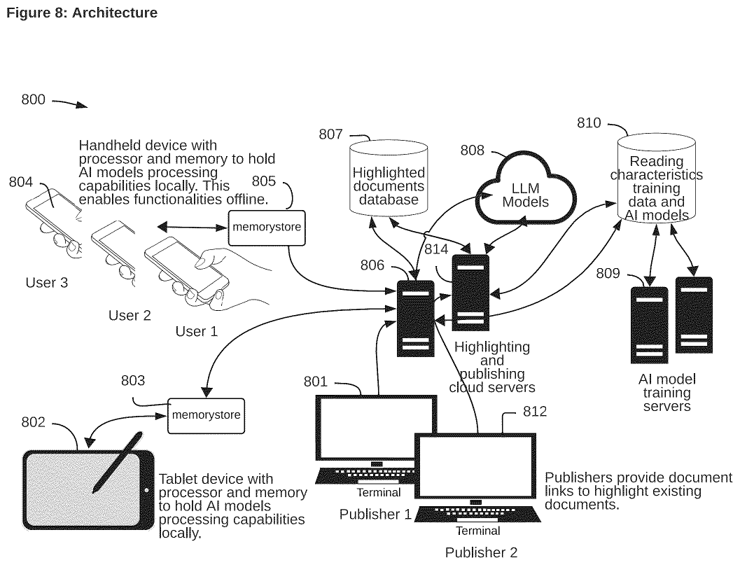

The systems of the present invention generally comprise user devices configured to capture user behavior data, a cluster of computing devices configured to store and process data and AI models based on a topic-specific dictionary, and a server configured to receive, process, and deliver enhanced documents to the user devices (FIG. 8).

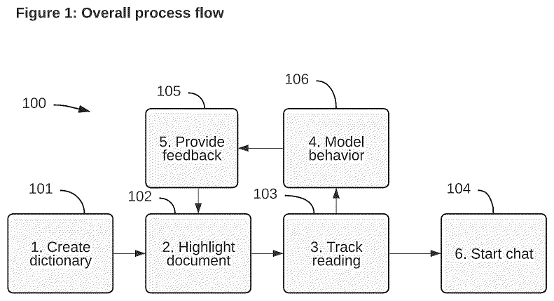

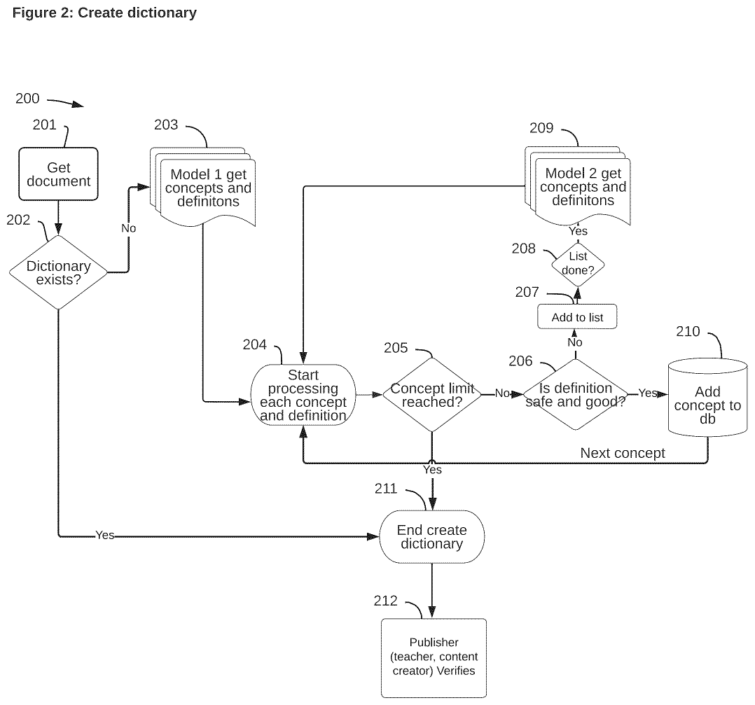

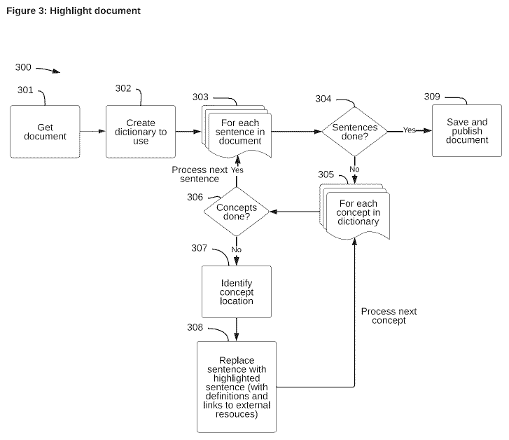

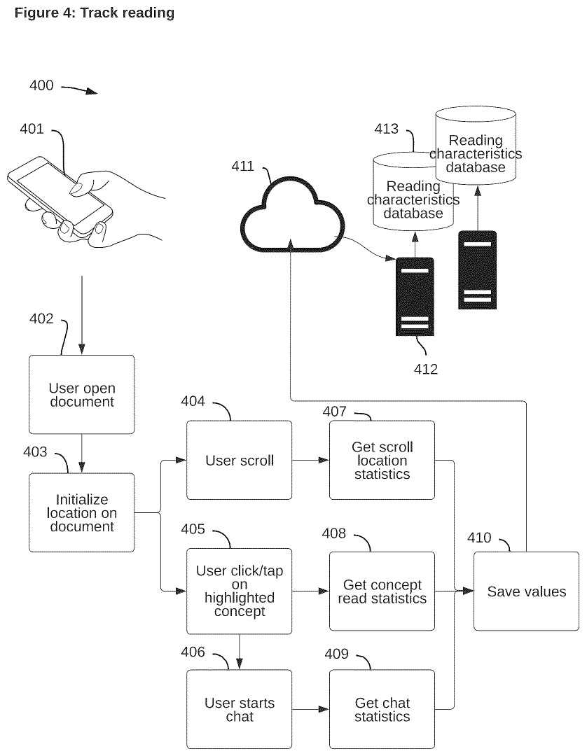

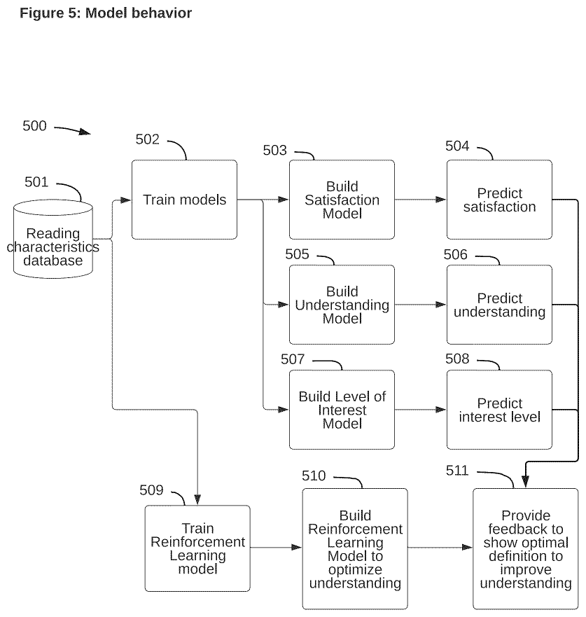

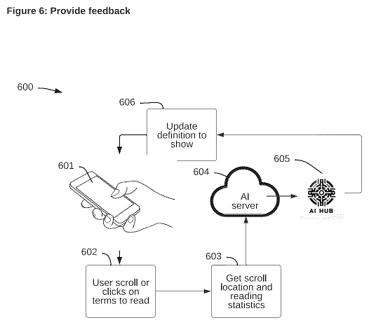

The overall flow of the methods is illustrated in FIG. 1 and broken down into steps in FIG. 2 to FIG. 7. The method includes creating a topic-specific dictionary of difficult terms, facts, concepts, and summary, verifying safety and accuracy of the definitions, illustrations, providing multiple definitions for each concept tailored to different levels of understanding (FIG. 2), processing a document to identify and highlight difficult terms, facts, and concepts based on the dictionary (FIG. 3), allowing users to access supplementary information related to the highlighted concepts (FIG. 4), tracking user behavior data to assess the reader's level of understanding, interest, and satisfaction (FIG. 4), utilizing algorithms to model and predict the reader's level of understanding, interest, and satisfaction based on the collected data (FIG. 5), and providing feedback to the reader based on AI models trained to optimize understanding (FIG. 6).

An exemplary system 800 in which embodiments of the present inventions can be implemented includes the following components as shown in FIG. 8:
1. Many users, their devices for reading articles, and the users scroll and click behaviors captured by the devices 801, 802, 804, 810 and 812. User scroll data is captured by the servers and stored in a database, which are then read by AI training servers.
2. Cluster of computing devices with memory and location architecture to hold and process data and Artificial Intelligence (AI) models. The data and models are distributed based on the topic dictionary.
   The AI models and processing capabilities can also be stored on a local client with circuit and memory to hold the models and processing algorithm to highlight and show the definition without having to go through the cloud servers as shown in FIG. 8. This structure enables local usage of the invention without online connectivity. It can be useful for scenarios where readers want to use Kindle-like devices to read the highlighted articles. The local memory and processor would collect the user scrolling and click behaviors and send them to the servers when connectivity is available.
3. Clusters of servers 803, 806, 807, 808, 809, 810 and 814, where each cluster is designed to highlight articles, serve users highlighted articles, and track user reading behaviors.

An exemplary method in which embodiments of the present inventions can be implemented include the following steps.
1. Create a dictionary of difficult concepts for particular subject matter. The subject matter can include topics like “ocean acidification.” An example of a concept will be “Ocean pH level” (FIG. 2).

The dictionary creation (200) can be manual, semi-automatic, or fully automatic. Once a publisher provides the source of the document to highlight (201), key concepts are identified (203) using a large language model. The invention also uses a crawling process to find related documents to refine an existing large language model and concepts in a looping process as shown in FIG. 2 (202, 203, 204, 205, 206, 207, 208, 209, 210, 211 and 212). Definitions are derived from a large language model or refined model from the crawled document. The definitions are also verified for accuracy and safety by a model. The eventual definitions are reviewed and approved by human experts. Publishers (teachers, content creators) enter document sources to highlight (201). If a dictionary does not exist (202), it gets created by using a large language model or by crawling the internet and other sources for documents containing the concepts in the interested document to fine-tune the large language model (203, 204, 205, 206, 207, 208, 209, 210, 211 and 212).
The dictionary contains multiple definitions for the same concept, tailored for audiences with different levels of understanding of the concept. Each concept definition can contain definition text, examples, illustrations, and videos.

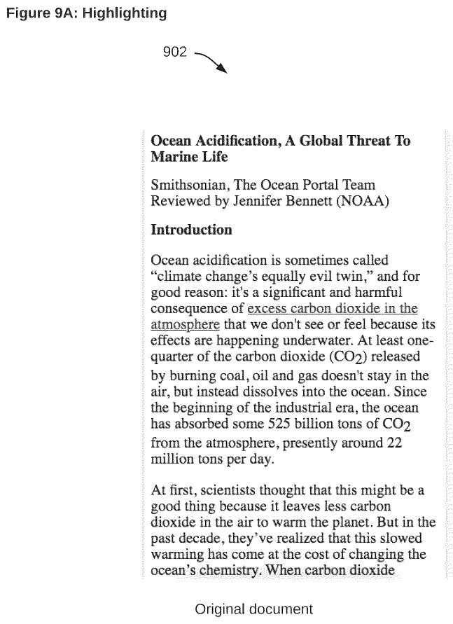

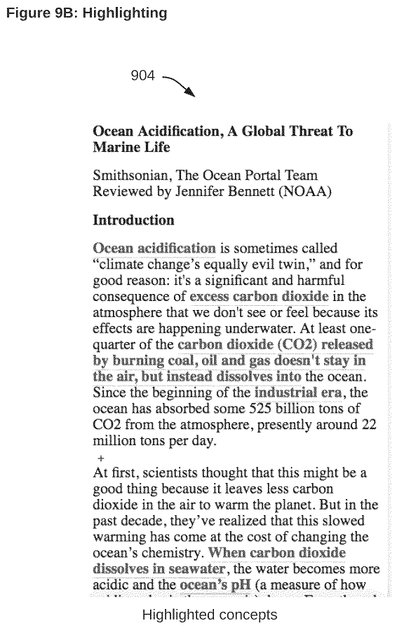

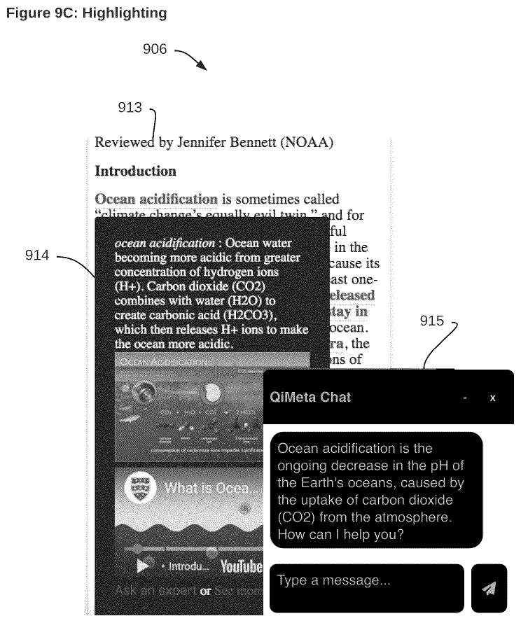

Read a document from a link or other sources like pdf or any local or online files.
2. The steps include (FIG. 3, 300):
   a. Extract the content.
   b. Parse it and process it to identify the concepts to highlight; concepts are based on the dictionary.
   c. Insert the highlighted concepts and definitions to create a new document (301, 302, 303, 304, 305, 306 and 307).
   d. Enable users to click or tap on the highlighted concept to show the definition in a pop up without leaving the document being read (308).
   e. Publish the document (309). Publishers enter the source of the document to highlight and publish it for users to read (301, 309). This process provides a link to be used to see the highlighted document. An example of the original document and the highlighted document along with the concept definition with illustration and video is shown in FIGS. 9A, 9B and 9C (902, 904, 906). These figures illustrate an example of an original document and highlighted document with definition on a pop-up and a way to engage with AI or human expert chatbot.
Track a reader's level of understanding based on how the reader scrolls or swipes and taps or clicks through the document. If other information on the user is available (i.e. age, grade level, interest level, gender, how many articles read, etc.), those can also be integrated as part of the features to model and predict user characteristics. Scroll behavior and level of understanding are captured through (FIG. 4 400) data collected below (401, 402, 403), but not limited to them. As users read a document, the users' scroll, click, and chat behaviors are captured by servers and stored in a dictionary-specific database.
   f. Scroll speed (404, 407).
   g. Highlighted concepts visited (405, 408).
   h. Location of concept in the document.
   i. Duration spent on a concept.
   j. Page time views-how long was the user on the page.
   k. Duration spent on a paragraph.
   l. Reader annotating or highlighting the document.
   m. Difficulty ranking of the concept by an expert.
   n. Device type.
   o. Assessment tests—provide users assessment tests pre-and post-tests to verify how well the user understood the document, their interest in the document, and their satisfaction level with the document (406, 409). These are utilized for training data (410, 411, 412, 413).
3. Model behavior based on the captured data in step 3. Utilize machine learning algorithms to train and predict the level of understanding, level of interest, and level of satisfaction identified in assessment tests and captured in the input features collected above (FIG. 5 500). The true labels are collected using assessment tests. That data is used for training.

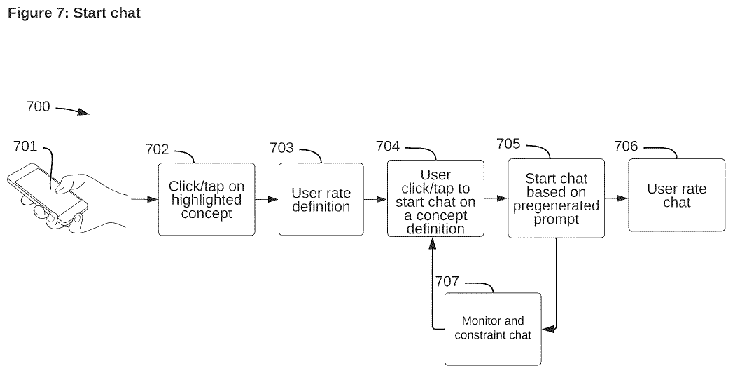

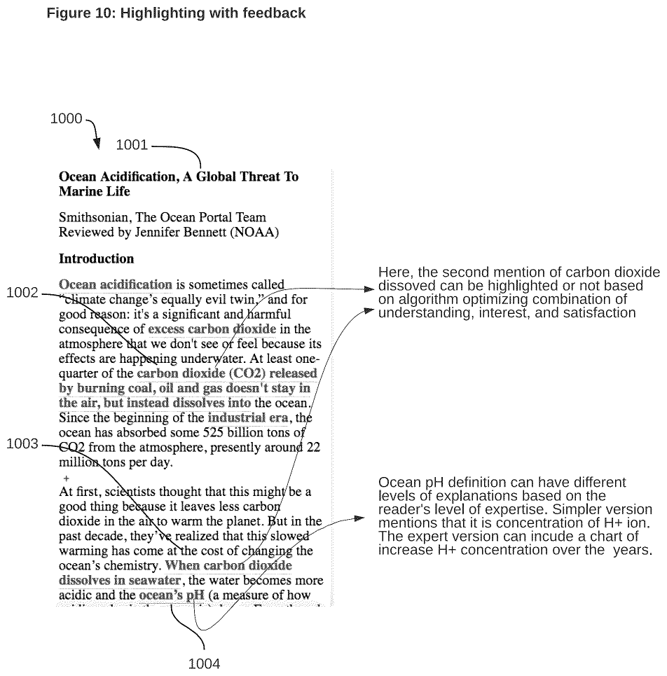

A general model is developed from all documents read for a topic dictionary (501, 502, 503, 504, 505, 506, 507, 508, 509, 510 and 511). For a new article, models are fine-tuned using smaller dataset. AI models are built from data collected to predict understanding, satisfaction, interest. Reinforcement learning and other algorithms used provide feedback update highlighted concept definitions based on user behavior.
4. Provide feedback to the reader in real time as the user scrolls the article (FIG. 6 600):
   a. Use a reinforcement learning algorithm which combines transformers, generative adversarial networks and diffusion algorithms to generate data and provide feedback to show the definitions that will optimize one or more of desired outcomes: understanding, interest and satisfaction. The reward model is based on the level of understanding, interest, and satisfaction.
   b. Based on the prediction in the above step, highlight the concepts that will optimize one or more of desired outcomes (601, 602, 603, 604, 605 and 606). AI models update highlighted concepts and definitions based on user behavior parameters collected with the goal of optimizing understanding.
      As an example, as shown in FIG. 10 (1000). The title of the content 1000 shown is “Ocean Acidification, A Global Threat To Marine Life.” In content 1000, one or both mentions of “carbon dioxide dissolved” 1002, 1003 can be shown or not shown based on the algorithm optimizing the combination of understanding, interest, and satisfaction. FIG. 10 illustrates an example of feedback which can highlight different concepts and show different definitions based on user characteristics to optimize understanding.
      As another example, “Ocean pH” 1004 definition can have different levels of definitions based on the reader's level of expertise. A simpler version can mention only that it is the level of H+ ion. The expert level version can show a chart showing pH increase over the years. The simpler version can be: “Ocean pH: Concentration of hydrogen ion (H+) in the ocean. It is a measure of how acidic or basic the ocean is. Lower pH is more acidic meaning greater concentration of positive H+ ions. Higher pH means the opposite, lower concentration H+ ions. Stable pH of the ocean is around 8.1.” The expert version can have a chart showing the trend over the years.
5. Provide a means to start a conversation with an automated system to start a discussion on the concept clicked (FIG. 7 700). At any point of reading a definition, the user can choose to start a discussion with an automated ChatGPT-like chatbot or a human expert (701, 702, 703, 704, 705, 706 and 707). Users can start a chat where the prompt is pre-generated based on the concept being visualized. The prompt to start the chat will be pre generated based on the concept being read. This makes the engagement with the chatbot easier and faster. The user can also click on a link to read more about the original document that the summary definition came from. The user can also be guided through links to external sources to learn more about a topic.

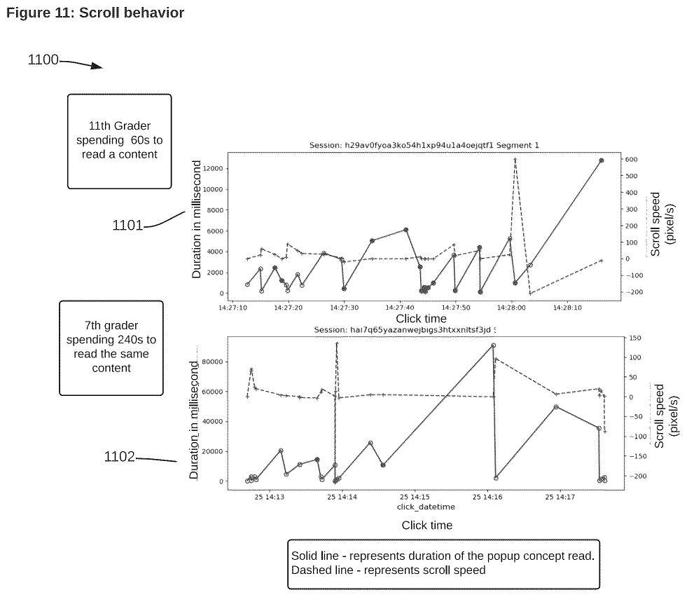

FIG. 11 illustrates examples of scroll behavior 1100. Specifically, it illustrates examples of the charting part of the scroll features, showing how the scroll patterns are different between 11th and 7th graders reading the same article. Eleventh graders read the same content faster than seventh graders (compare dashed lines between 1101 and 1102) and used less click time meaning they also read the pop-up faster than seventh graders (compare solid lines between 1101 and 1102).

What is claimed is:

1. A method, comprising:
displaying, by a computer system comprising at least one processor and a display, user readable text; and
in response to selection of a word or a phrase by a user, providing generative artificial intelligence (AI) information about the selected word or phrase.

2. The method of claim 1, wherein the selection can be done with one of a voice command, a tap, a touch, a stare, or by using a computer mouse.

3. The method of claim 1, wherein the generative AI information is provided via a pop-up text box.

4. The method of claim 3, wherein the pop-up text box comprises a hyperlink to a website on the world wide web.

5. The method of claim 3, wherein the pop-up text box is manually editable.

6. The method of claim 1, wherein the generative AI information is provided via one of an audio message, a video message, or an image.

7. The method of claim 1, further comprising: upon determining that the generative AI information is inaccurate or inappropriate providing a different generative AI information.

8. The method of claim 1, further comprising: in response to selection of the word or the phrase by a user for a second time, providing different generative AI information about the selected word or phrase from the previously provided generative AI information;
wherein, the different information is generated by a machine learning model (MLL);
wherein, the MLL is trained by using captured data about the user; and
wherein, the different information is generated by the MLL in real time in response to selection of the word or the phrase by the user for the second time.

9. A non-transitory machine-readable medium, comprising executable instructions that, when executed by at least one processor of a system, facilitate performance of operations, comprising:
displaying, by a computer system comprising at least one processor and a display, user readable text; and
in response to selection of a word or a phrase by a user, providing generative artificial intelligence (AI) information about the selected word or phrase.

10. The non-transitory machine-readable medium of claim 9, wherein the selection can be done with one of a voice command, a tap, a touch, a stare, or by using a computer mouse.

11. The non-transitory machine-readable medium of claim 9, wherein the generative Al information is provided via a pop-up text box.

12. The non-transitory machine-readable medium of claim 11, wherein the pop-up text box comprises a hyperlink to a website on the world wide web.

13. The non-transitory machine-readable medium of claim 11, wherein the pop-up text box is manually editable.

14. The non-transitory machine-readable medium of claim 9, wherein the generative AI information is provided via one of an audio message, a video message, or an image.

15. The non-transitory machine-readable medium of claim 9, further comprising: upon determining that the generative AI information is inaccurate or inappropriate providing a different generative AI information.

16. The non-transitory machine-readable medium of claim 9, further comprising: in response to selection of the word or the phrase by a user for a second time, providing different generative AI information about the selected word or phrase from the previously provided generative AI information;
wherein, the different information is generated by a machine learning model (MLL);
wherein, the MLL is trained by using captured data about the user; and
wherein, the different information is generated by the MLL in real time in response to selection of the word or the phrase by the user for the second time.

17. A system, comprising:
a computer system comprising at least one processor and a display;
a first component configured to display user readable text on the display; and
a second component configured to providing generative artificial intelligence (AI) information about the selected word or phrase in response to selection of a word or a phrase by a user.

18. The system of claim 17, wherein the selection can be done with one of a voice command, a tap, a touch, a stare, or by using a computer mouse.

19. The system of claim 17, wherein the generative AI information is provided via a pop-up text box.

20. The system of claim 17, wherein the pop-up text box is manually editable.
